(19) United States
(12) Patent Application Publication
(10) Pub. No.: US 2026/0206868 A1
(43) Pub. Date: Jul. 23, 2026

(54) AEROSOL-GENERATING APPARATUS WITH COUNTERFEIT RECOGNITION

(71) Applicant: PHILIP MORRIS PRODUCTS S.A., Neuchâtel (CH)

(72) Inventors: Rui Nuno Rodrigues Alves BATISTA, Neuchâtel (CH); Alexandra SEREDA, Neuchâtel (CH)

(21) Appl. No.: 19/139,998

(22) PCT Filed: Dec. 13, 2023
(86) PCT No.: PCT/IB2023/062573

§ 371 Date: Jun. 17, 2025

(30) Foreign Application Priority Data
Dec. 19, 2022 (EP) 22214759.7

(51) Int. Cl. A24F 40/53; A24F 40/51; G06K 7/10

(52) U.S. Cl. CPC A24F 40/53; A24F 40/51; G06K 7/10297; G06K 7/10366

(57) ABSTRACT

An apparatus configured to interact with a consumable to produce an aerosol, the apparatus includes a receptacle configured to receive the consumable, a sensor configured to detect a feature of the consumable received in the receptacle, a control unit operatively coupled to the sensor and configured to determine whether the detected feature is indicative of authenticity of the consumable, and one or both of a scent releasing unit and a marking unit. The scent releasing unit is operatively coupled to the control unit, and the control unit is configured to cause the scent releasing unit to release a scent when the control unit determines that the consumable is not authentic. The marking unit is operatively coupled to the control unit, and the control unit is configured to cause the marking unit to mark the consumable received in the receptacle when the control unit determines that the consumable is not authentic.

The present disclosure relates to an aerosol-generating apparatus or device that releases a scent, marks a consumable, or releases a scent and marks a consumable if the aerosol-generating apparatus or device determines that the consumable is not authentic or is counterfeit.

There is increasing demand for handheld aerosol-generating systems or devices that deliver aerosol for user inhalation. Some aerosol-generating devices operate by heating an aerosol-forming substrate with a heating element. Some devices operate by inserting an electrical heater into a solid aerosol-forming substrate and supplying power to the heater from a battery included in the device. Aerosol-generating devices may generate aerosol from an aerosol-generating substrate in response to a user action, such as a puff. Users typically hold aerosol-generating devices while puffing and in between puffs.

Known handheld electrically operated aerosol-generating systems typically include an aerosol-generating device or a main unit comprising a battery, control electronics and an electric heater for heating an aerosol-generating article designed specifically for use with the aerosol-generating device. In some examples, the aerosol-generating article comprises an aerosol-generating substrate, such as a tobacco rod or a tobacco plug. Aerosol-generating substrates, such as tobacco, typically include one or more volatile compounds that form an aerosol when heated inside the aerosol-generating device. The aerosol-generating device may heat but not burn the aerosol-generating substrates. The heater contained within the aerosol-generating device is inserted into or around the aerosol-generating substrate when the aerosol-generating article is inserted into the aerosol-generating device. In some electrically operated aerosol-generating systems, the aerosol-generating article may include a capsule containing an aerosol-generating substrate, such as loose tobacco.

Consumers may use counterfeit consumable products for their aerosol-generating systems by acquiring it in the market where counterfeits are distributed within the existing standard supply chain. Counterfeit consumable products may be difficult to detect by consumers. Counterfeit consumable products may unintentionally influence the performance of the device, negatively influencing the overall consumer experience. Counterfeit consumables are not subject to quality controls and may lead to adverse health consequences to its consumers. Furthermore, consumers unintentionally may influence the lifetime of their devices negatively by using counterfeit consumables and even can provoke malfunction or nonfunction of their devices.

It would be desirable to provide an aerosol generating device that recognizes non-authentic or counterfeit consumables and provides consumers or others an indication that the consumable is non-authentic or counterfeit.

It would be desirable to provide an indication that the consumable is non-authentic or counterfeit to prevent further use of the non-authentic or counterfeit consumable.

It would be desirable to provide an indication that the consumable is non-authentic to encourage a user to stop using the non-authentic consumable.

It would be desirable that counterfeit products could be discernable after its recognition as not original products. Namely discernable to its consumers and people or in the proximity of the consumer.

Aerosol-generating system or apparatus described herein are configured to identify counterfeit consumables and inform the consumer, as well as other persons potentially, about the recognition and identification of counterfeit consumables. The aerosol-generating system or apparatus includes a recognition unit configured to determine whether a detected feature is indicative of authenticity of the consumable. The aerosol-generating system or apparatus may release a scent, mark the consumable, or both to alert the consumer and potentially other persons in the proximity of the consumer of the authenticity of the consumable.

An apparatus is configured to interact with a consumable to produce an aerosol. The apparatus includes a receptacle configured to receive the consumable, a sensor configured to detect a feature of the consumable when the consumable is received in the receptacle, a control unit operatively coupled to the sensor and configured to determine whether the detected feature is indicative of authenticity of the consumable, and one or both of a scent releasing unit and a marking unit. The scent releasing unit is operatively coupled to the control unit, and the control unit is configured to cause the scent releasing unit to release a scent when the control unit determines that the consumable is not authentic. The marking unit is operatively coupled to the control unit, and the control unit is configured to cause the marking unit to mark the consumable received in the receptacle when the control unit determines that the consumable is not authentic.

In case of detection of an unauthentic consumable, the control unit of the device may activate a scent releasing unit which can release an unpleasant or offensive scent. This way the consumer will associate the unpleasant or offensive scent with the counterfeit consumable. The control unit may activate a marking unit which can label the consumable with a counterfeit identification mark. This way, the consumption of counterfeit products will be discernable for the consumer, as well as to other consumers and people, after its recognition by the device.

In addition, if the consumable is determined to not be authentic, the aerosol generating device may not be able to be activated to produce an aerosol from the consumable.

Advantageously, the aerosol-generating device may actively notify the consumer that the consumable is not authentic. Realizing that the consumable is not authentic may dissuade a consumer from using non-authentic consumables with the aerosol-generating device. Having an aerosol-generating device may actively notify persons proximate to the consumer that the consumable is not authentic may further dissuade a consumer from using non-authentic consumables with the aerosol generating device. Releasing an offensive scent or odor form the aerosol-generating device may provide a public notification to further dissuade a consumer from using non-authentic consumables with the aerosol generating device. Placing an obvious marking on the counterfeit consumable may also provide public notification to further dissuade a consumer from using non-authentic consumables with the aerosol generating device.

All scientific and technical terms used herein have meanings commonly used in the art unless otherwise specified. The definitions provided herein are to facilitate understanding of certain terms used frequently herein.
The phrase “feature of the consumable” refers to the presence or absence of a detectable aspect or element. Useful detectable aspects or elements include, for example, an RFID tag, a chromatic or spectroscopic element, security element, and the like.
The term “authentic” refers to an article that is manufactured by the attributed manufacturer or authorised entity that the article refers to.
The term “counterfeit” or “inauthentic” refers to an article that mis-represents the origin of the article, such as a fake, imitation, or unauthorised replica.
The term “control unit”, “controller”, or “processor” refers to any device or apparatus capable of providing suitable computing capabilities and control capabilities such as, e.g., microprocessors, digital signal processors (DSP), application specific integrated circuits (ASIC), field-programmable gate arrays (FPGA), equivalent discrete or integrated logic circuitry, or any combination thereof and of providing suitable data storage capabilities that includes any medium (e.g., volatile or non-volatile memory, a CD-ROM, magnetic recordable medium such as a disk or tape, etc.) containing digital bits (e.g., encoded in binary, trinary, etc.) that may be readable and/or writeable.
The term “aerosol-generating apparatus” or “aerosol-generating device” refers to an apparatus or device configured to use an aerosol-generating article or substrate to generate aerosol. In some embodiments, the aerosol-generating apparatus or device may be described as a smoking article or a holder, particularly a tobacco stick holder or “heat stick” holder. Preferably, the aerosol-generating apparatus or device also includes an aerosolizer. The aerosolizer may include an atomizer, cartomizer, heater, or other aerosolizing components.
The term “aerosol-generating article” or “aerosol-generating substrate” refers to a article or substrate that releases compounds that may form an aerosol to be inhaled by a user. In some cases, the substrate may release volatile compounds upon heating. Preferably, the aerosol-generating substrate includes nicotine. Suitable aerosol-forming substrates may include plant-based material. For example, the aerosol-generating substrate may include tobacco or a tobacco-containing material containing volatile tobacco flavor compounds, which are released from the aerosol-generating substrate upon heating. In addition, or alternatively, an aerosol-generating substrate may include a non-tobacco containing material. The aerosol-generating substrate may include homogenized plant-based material. The aerosol-generating substrate may include at least one aerosol former. The aerosol-generating substrate may include other additives and ingredients such as flavorants. In some embodiments, the aerosol-generating substrate is a liquid at room temperature. For example, the aerosol-generating substrate may be a liquid solution, suspension, dispersion or the like. A liquid aerosol-generating substrate may include glycerol, propylene glycol, water, nicotine and, optionally, one or more flavorants. In some embodiments, the aerosol-generating substrate is a solid at room temperature, such as a tobacco stick or nicotine powder.
The term “tobacco material” refers to a material or substance including tobacco, which includes tobacco blends or flavored tobacco, for example.

Having defined certain frequently-used terms, aerosol-generating apparatus or device of the present disclosure will be described herein in more detail. In general, the aerosol-generating apparatus or device includes a recognition unit or sensor configured to determine whether a detected feature on or in a consumable is indicative of authenticity of the consumable. The aerosol-generating system or apparatus may release a scent, mark the consumable, or both to alert the consumer and potentially other persons in the proximity of the consumer of the authenticity of the consumable.

The apparatus or aerosol-generating device includes an aerosolizer. The aerosolizer is contained by the housing when used. The aerosolizer is configured to generate aerosol from an aerosol-generating substrate contained within the consumable. Any suitable type of aerosolizer may be used. In some cases, the aerosolizer may be thermally or fluidly coupled to the aerosol-forming substrate. The aerosolizer may be compatible for use with various types of aerosol-generating substrates.

The aerosolizer may include a heating element such as, for example, a heating blade for use with a solid aerosol-generating substrate. The heating blade may be coupled to the housing of the aerosol-generating device to receive electrical power from a power source (battery). For example, the aerosol-generating substrate may be provided in the form of a consumable such as a heat stick. The heating blade may be inserted into the consumable or heat stick and heated to generate aerosol from the solid substrate. The solid substrate may be a smoking material, such as tobacco. The heat provided by the heating element or heating blade to the heat stick preferably does not burn the smoking material.

The aerosolizer may include a heater, a heater coil, a chemical heat source (such as a carbon heat source), or any suitable means that heats the substrate to generate aerosol. The aerosolizer may be coupled to the housing of the aerosol-generating device to receive electrical power from a power source (battery) and may be disposed adjacent to the substrate. For example, a heating element of a heater may be disposed adjacent to the aerosol-generating substrate and heated to generate aerosol from a liquid or solid substrate. A heater coil may include a susceptor adjacent to the aerosol-forming substrate and when an energized inductive coil is disposed adjacent to the susceptor, electromagnetic energy may be transferred to the susceptor to heat the substrate within the consumable.

The aerosolizer may include an atomizer. A liquid aerosol-generating substrate may be contained in the substrate housing and in fluid communication with the atomizer. The atomizer may mechanically generate aerosol from the liquid substrate instead of relying only on temperature.

The aerosolizer may be compatible for use with an aerosol-generating substrate having a nicotine source and a lactic acid source. The nicotine source may include a sorption element, such as a PTFE wick with nicotine adsorbed thereon, which may be inserted into a chamber forming a first compartment. The lactic acid source may include a sorption element, such as a PTFE wick, with lactic acid adsorbed thereon, which may be inserted into a chamber forming a second compartment. The aerosolizer may include a heater to heat both the nicotine source and the lactic acid source. Then, the nicotine vapor may react with the lactic acid vapor in the gas phase to form an aerosol.

The aerosol-generating substrate is at least partially disposed in the aerosol-generating device when used. The aerosol-generating substrate may be removable after being consumed. A new aerosol-generating substrate may be received by the aerosol-generating device to replace the consumed substrate.

The aerosol-generating substrate is disposed within the consumable. The consumable may be referred to as a “heat stick”, where the aerosol-generating substrate forms a first portion of an elongated consumable, and a mouthpiece forms the opposing portion of the elongated consumable. The aerosol-generating substrate side of the consumable is inserted in the aerosol-generating device or apparatus for use by the consumer. A recognition element may be disposed on the outer surface of the consumable. A recognition element may be disposed within the outer surface of the consumable.

The aerosol-generating device or apparatus is configured to interact with a consumable to produce an aerosol. The apparatus includes a receptacle configured to receive the consumable, a sensor is configured to detect a feature of the consumable when the consumable is received in the receptacle. A control unit is operatively coupled to the sensor and configured to determine whether the detected feature is indicative of authenticity of the consumable. The apparatus further includes one or both of a scent releasing unit and a marking unit

The scent releasing unit is operatively coupled to the control unit when present. The control unit is configured to cause the scent releasing unit to release a scent when the control unit determines that the consumable is not authentic or is counterfeit.

The marking unit is operatively coupled to the control unit when present. The control unit is configured to cause the marking unit to mark the consumable received in the receptacle when the control unit determines that the consumable is not authentic or is counterfeit.

The sensor may be any useful sensor able to interrogate a detectable feature on or in the consumable to determine the authenticity of the consumable. The sensor may be disposed within the receptacle of the apparatus. The sensor may be disposed within the receptacle of the apparatus and be proximate to the outer surface of the consumable received in the receptacle of the apparatus. The sensor may define an annular ring where the consumable received in the receptacle of the apparatus is disposed within the annular ring.

The sensor may be a radio frequency identification (RFID) sensor or reader that emits radio waves and receives signals back from a corresponding radio frequency identification (RFID) tag recognition element on the consumable. The RFID tag recognition element on the consumable may be a passive element that is powered by the (RFID) sensor or reader. The RFID reader or sensor is configured to interrogate the (RFID) tag recognition element on the consumable to verify the authenticity of the consumable by its transmitted data.

The sensor may be a chromatic, spectroscopic, or light sensor that is configured to interrogate or read a corresponding recognition element on the consumable. The recognition element may be include a taggant or chromatic security feature to verify the authenticity of the consumable by its spectroscopic or taggant signature.

In some embodiments the apparatus includes the scent releasing unit but not the marking unit. In some embodiments the apparatus includes the marking unit but not the scent releasing unit. In some the apparatus includes both the scent releasing unit and the marking unit.

The scent releasing unit may be configured to release a compound having an unpleasant or offensive odor. The scent releasing unit may be contained within the housing of the apparatus. The scent releasing unit may be contained within the receptacle of the apparatus. The scent releasing unit may be located proximate to a closed end of the receptacle of the aerosol-generating apparatus. The scent releasing unit is operably coupled to the control unit and the control unit may activate the scent releasing unit (when present) upon detecting a counterfeit or inauthentic consumable received in the receptacle of the apparatus.

The scent releasing unit may include at least one scent releasing elements such as a heater or heating element, a vibration generator, an ultrasonic or piezoelectric transducer, an atomizer, or any other actuator to energize particles of a scent such that the particles are released from a scent container or cartridge into a gas form or microscopic droplets that can be carried off by an airstream passing through a scent-flow channel, between the consumable and the receptacle. The receptacle may be wave-shaped at its inner surface, to improve transmission of an airstream passing through the scent-flow channel and for holding the consumable, housed in the receptacle, securely in its position.

The scent releasing unit may include a heater configured to heat a substrate containing the compound and causing the compound to be released. The scent releasing element may be a mesh heater configured to heat and releases a scent from a flavored liquid-soaked high retention material or substrate incorporated in the scent cartridge. The released scent may be directed toward the consumer of the consumable via a channel or scent-flow channel. The released scent may be directed out of the aerosol-generating apparatus at the opening of the receptacle of the aerosol-generating apparatus and toward the consumer.

If inauthenticity of a consumable is detected by the sensor, the control unit may activate the scent releasing unit and release an unpleasant scent from the aerosol-generating apparatus toward the consumer of the counterfeit consumable. One example of an unpleasant scent is perceived as strongly bitter and is composed by a suitable aroma and glycol. Other unpleasant scents include, for example, ammonia compounds, or sulfur compounds. By releasing an unpleasant scent when detecting a counterfeit consumable, a consumer will potentially associate the scent with the counterfeit consumable and will more likely not use counterfeit consumables in the future.

The marking unit is configured to place in indicia onto the surface of the consumable to provide visual evidence that it is a counterfeit consumable. The indica provided by the marking unit may be any useful indication of authenticity, such as, the terms “VOID”, “FAKE”, “COUNTERFEIT”, or “DEFECTIVE”, for example. The marking unit provide the mark or indicia by printing, burning, and the like.

The marking unit may include a heater configured to burn the visible marking or indicia into the consumable. The marking unit may be contained within the housing of the apparatus. The marking unit may be contained within the receptacle of the apparatus. The marking unit may be located proximate the body of the consumable when the consumable is received in the receptacle of the apparatus. The marking unit is operably coupled to the control unit and the control unit may activate the marking unit upon detecting a counterfeit or inauthentic consumable received in the receptacle of the apparatus.

The marking unit may mark the consumable while received in the receptacle of the apparatus. When the inauthenticity of a consumable is detected by the sensor, the control unit activates the marking unit to label the counterfeit identification mark in a visible area of the consumable. The marking unit may be designed incorporating at least one heating element able to burn-in individual letters, symbols or a word, such as “VOID”, “FAKE”, “COUNTERFEIT”, or “DEFECTIVE” into the consumable, when an inauthentic consumable is detected within the receptacle of the apparatus.

To power the apparatus described herein, the operation of a sensor, control unit, the scent releasing unit, and the marking unit, a power source is electrically connected to supply the required energy. The power source is disposed within the housing of the apparatus.

An actuation element or actuation button is operatively coupled to the control unit. The actuation element is configured to be actuated by a user of the apparatus. Actuation of the actuation element causes the control unit to determine whether the detected feature is indicative of authenticity of the consumable. Actuation of the actuation element causes the control unit to activate one or both of the marking unit or scent releasing unit if the detected feature is indicative of inauthenticity of the consumable.

Actuation of the actuation element is configured to cause the apparatus to interact with the consumable to produce the aerosol if the control unit determines that the consumable is authentic. In many embodiments, the control unit is configured to prevent the apparatus from interacting with the consumable to produce the aerosol if the control unit determines that the consumable is not authentic.

The control unit of the apparatus may be contained by the housing of the aerosol-generating device or apparatus. The control unit is configured to activate the aerosolizer to generate aerosol from the consumable aerosol-forming substrate.

The control unit may include memory. The memory may be used to store various types of data, such as the authenticity data. Stored authenticity data may be later used, displayed, or communicated. In one example, authenticity data may be determined and stored on the control unit. The control unit may be provided in any suitable form and may, for example, include a processor and a memory. Generally, the control unit includes memory that contains instructions that cause one or more components to carry out a function or aspect of the control unit. Functions attributable to controller in this disclosure may be embodied as one or more of software, firmware, and hardware.

The control unit described herein may include a processor, such as a central processing unit (CPU), computer, logic array, or other device capable of directing data coming into or out of the controller. The control unit may include one or more computing devices having memory, processing, and communication hardware. The control unit may include circuitry used to couple various components of the control unit together or with other components operably coupled to the control unit. The functions of the control unit may be performed by hardware and/or as computer instructions on a non-transient computer readable storage medium.

The processor of the control unit may include any one or more of a microprocessor, a microcontroller, a digital signal processor (DSP), an application specific integrated circuit (ASIC), a field-programmable gate array (FPGA), and/or equivalent discrete or integrated logic circuitry. In some examples, the processor may include multiple components, such as any combination of one or more microprocessors, one or more controllers, one or more DSPs, one or more ASICS, and/or one or more FPGAs, as well as other discrete or integrated logic circuitry. The functions attributed to the control unit or processor herein may be embodied as software, firmware, hardware, or any combination thereof. While described herein as a processor-based system, an alternative controller could utilize other components such as relays and timers to achieve the desired results, either alone or in combination with a microprocessor-based system.

In one or more embodiments, the exemplary systems, methods, and interfaces may be implemented using one or more computer programs using a computing apparatus, which may include one or more processors and/or memory. Program code and/or logic described herein may be applied to input data/information to perform functionality described herein and generate desired output data/information. The output data/information may be applied as an input to one or more other devices and/or methods as described herein or as would be applied in a known fashion. In view of the above, it will be readily apparent that the control unit functionality as described herein may be implemented in any manner known to one skilled in the art.

The invention is defined in the claims. However, below there is provided a non-exhaustive list of non-limiting examples. Any one or more of the features of these examples may be combined with any one or more features of another example, embodiment, or aspect described herein.
Example Ex1: An apparatus configured to interact with a consumable to produce an aerosol, the apparatus comprising: a receptacle configured to receive the consumable; a sensor configured to detect a feature of the consumable when the consumable is received in the receptacle; a control unit operatively coupled to the sensor and configured to determine whether the detected feature is indicative of authenticity of the consumable; and one or both of a scent releasing unit and a marking unit, wherein the scent releasing unit is operatively coupled to the control unit, and the control unit is configured to cause the scent releasing unit to release a scent when the control unit determines that the consumable is not authentic, and wherein the marking unit is operatively coupled to the control unit, and the control unit is configured to cause the marking unit to mark the consumable received in the receptacle when the control unit determines that the consumable is not authentic.
Example Ex2: The apparatus of Example Ex1, wherein the sensor comprises an RFID reader.
Example Ex3. The apparatus of Example Ex1 or Example Ex2, comprising the scent releasing unit.
Example Ex4. The apparatus of Example Ex3, wherein the scent releasing unit is configured to release a compound having an unpleasant odor.
Example Ex5. The apparatus of Example Ex4, wherein the scent releasing unit comprises a heater configured to heat a substrate comprising the compound, wherein heating the substrate causes the compound to be released.
Example Ex6. The apparatus of Example Ex4 or Example Ex5, comprising a channel configured to carry the released compound towards a consumer of the consumable.
Example Ex7. The apparatus of Example Ex1 or Example Ex2, comprising the marking unit.
Example Ex8. The apparatus of Example Ex7, wherein the marking unit comprises a heater configured to burn a visible marking into the consumable.
Example Ex9. The apparatus of any one of Examples Ex1 to Ex8, wherein the apparatus comprises an actuation element operatively coupled to the control unit, wherein the actuation unit is configured to be actuated by a user of the apparatus, and wherein actuation of the actuation element causes the control unit to determine whether the detected feature is indicative of authenticity of the consumable.
Example Ex10. The apparatus of Example Ex9, wherein actuation of the actuation element is configured to cause the apparatus to interact with the consumable produce the aerosol if the control unit determines that the consumable is authentic.
Example Ex11. The apparatus of Example Ex10, wherein the control unit is configured to prevent the apparatus from interacting with the consumable to produce the aerosol if the control unit determines that the consumable is not authentic.
Example Ex12. A method for indicating inauthenticity of a consumable inserted into a receptacle of an aerosol generating apparatus, comprising: determining that the consumable inserted in the receptacle is not authentic; and one or both of releasing a scent from the apparatus and marking the consumable after the consumable is inserted into the receptacle.

### Example Ex13. the Method of Example Ex12, Comprising Releasing the Scent.

Example Ex14. The method of Example Ex13, wherein the released scent has an unpleasant odor.
Example Ex15. The method of any one of Examples Ex12 to Ex14, wherein the method comprises marking the consumable with a visible marking.
Example Ex16: An apparatus configured to interact with a consumable to produce an aerosol, the apparatus comprising: a receptacle configured to receive the consumable; a sensor configured to detect a feature of the consumable when the consumable is received in the receptacle; a control unit operatively coupled to the sensor and configured to determine whether the detected feature is indicative of authenticity of the consumable; and a scent releasing unit, wherein the scent releasing unit is operatively coupled to the control unit, and the control unit is configured to cause the scent releasing unit to release a scent when the control unit determines that the consumable is not authentic.
Example Ex17: The apparatus of Example Ex16, wherein the sensor comprises an RFID reader.
Example Ex18. The apparatus of Example Ex16 or Example Ex17, comprising the scent releasing unit.
Example Ex19. The apparatus of Example Ex18, wherein the scent releasing unit is configured to release a compound having an unpleasant odor including ammonia or sulphur compounds.
Example Ex20. The apparatus of Example Ex19, wherein the scent releasing unit comprises a heater configured to heat a substrate comprising the compound, wherein heating the substrate causes the compound to be released.
Example Ex21. The apparatus of Example Ex19 or Example Ex20, comprising a channel configured to carry the released compound towards a consumer of the consumable.
Example Ex22. The apparatus of any one of Examples Ex16 to Ex21, wherein the apparatus comprises an actuation element operatively coupled to the control unit, wherein the actuation unit is configured to be actuated by a user of the apparatus, and wherein actuation of the actuation element causes the control unit to determine whether the detected feature is indicative of authenticity of the consumable.
Example Ex23. The apparatus of Example Ex22, wherein actuation of the actuation element is configured to cause the apparatus to interact with the consumable produce the aerosol if the control unit determines that the consumable is authentic.
Example Ex24. The apparatus of Example Ex23, wherein the control unit is configured to prevent the apparatus from interacting with the consumable to produce the aerosol if the control unit determines that the consumable is not authentic.
Example Ex25. A method for indicating inauthenticity of a consumable inserted into a receptacle of an aerosol generating apparatus, comprising: determining that the consumable inserted in the receptacle is not authentic; and releasing a scent from the apparatus after the consumable is inserted into the receptacle.

### Example Ex26. the Method of Example Ex25, Comprising Releasing the Scent.

Example Ex27. The method of Example Ex26, wherein the released scent has an unpleasant odor including ammonia or sulphur compounds.
Example Ex28: An apparatus configured to interact with a consumable to produce an aerosol, the apparatus comprising: a receptacle configured to receive the consumable; a sensor configured to detect a feature of the consumable when the consumable is received in the receptacle; a control unit operatively coupled to the sensor and configured to determine whether the detected feature is indicative of authenticity of the consumable; and a marking unit, wherein the marking unit is operatively coupled to the control unit, and the control unit is configured to cause the marking unit to mark the consumable received in the receptacle when the control unit determines that the consumable is not authentic.
Example Ex29: The apparatus of Example Ex28, wherein the sensor comprises an RFID reader.
Example Ex30. The apparatus of Example Ex28 or Example Ex29, comprising the marking unit.
Example Ex31. The apparatus of Example Ex30, wherein the marking unit comprises a heater configured to burn a visible marking into the consumable.
Example Ex32. The apparatus of any one of Examples Ex28 to Ex31, wherein the apparatus comprises an actuation element operatively coupled to the control unit, wherein the actuation unit is configured to be actuated by a user of the apparatus, and wherein actuation of the actuation element causes the control unit to determine whether the detected feature is indicative of authenticity of the consumable.
Example Ex33. The apparatus of Example Ex32, wherein actuation of the actuation element is configured to cause the apparatus to interact with the consumable produce the aerosol if the control unit determines that the consumable is authentic.
Example Ex34. The apparatus of Example Ex330, wherein the control unit is configured to prevent the apparatus from interacting with the consumable to produce the aerosol if the control unit determines that the consumable is not authentic.
Example Ex35. A method for indicating inauthenticity of a consumable inserted into a receptacle of an aerosol generating apparatus, comprising: determining that the consumable inserted in the receptacle is not authentic; and marking the consumable after the consumable is inserted into the receptacle.
Example Ex36. The method of Example Ex35, wherein the method comprises marking the consumable with a visible marking.
Example Ex37: An apparatus configured to interact with a consumable to produce an aerosol, the apparatus comprising: a receptacle configured to receive the consumable; a sensor configured to detect a feature of the consumable when the consumable is received in the receptacle; a control unit operatively coupled to the sensor and configured to determine whether the detected feature is indicative of authenticity of the consumable; and both of a scent releasing unit and a marking unit, wherein the scent releasing unit is operatively coupled to the control unit, and the control unit is configured to cause the scent releasing unit to release a scent when the control unit determines that the consumable is not authentic, and wherein the marking unit is operatively coupled to the control unit, and the control unit is configured to cause the marking unit to mark the consumable received in the receptacle when the control unit determines that the consumable is not authentic.
Example Ex38: The apparatus of Example Ex37, wherein the sensor comprises an RFID reader.
Example Ex39. The apparatus of Example Ex37 or Example Ex38, comprising the scent releasing unit.
Example Ex40. The apparatus of Example Ex39, wherein the scent releasing unit is configured to release a compound having an unpleasant odor.
Example Ex41. The apparatus of Example Ex40, wherein the scent releasing unit comprises a heater configured to heat a substrate comprising the compound, wherein heating the substrate causes the compound to be released.
Example Ex42. The apparatus of Example Ex40 or Example Ex41, comprising a channel configured to carry the released compound towards a consumer of the consumable.
Example Ex43. The apparatus of one or more of Examples Ex37 to Example Ex42, comprising the marking unit.
Example Ex44. The apparatus of Example Ex43, wherein the marking unit comprises a heater configured to burn a visible marking into the consumable.
Example Ex45. The apparatus of one or more of Examples Ex37 to Ex44, wherein the apparatus comprises an actuation element operatively coupled to the control unit, wherein the actuation unit is configured to be actuated by a user of the apparatus, and wherein actuation of the actuation element causes the control unit to determine whether the detected feature is indicative of authenticity of the consumable.
Example Ex46. The apparatus of Example Ex45, wherein actuation of the actuation element is configured to cause the apparatus to interact with the consumable produce the aerosol if the control unit determines that the consumable is authentic.
Example Ex47. The apparatus of Example Ex46, wherein the control unit is configured to prevent the apparatus from interacting with the consumable to produce the aerosol if the control unit determines that the consumable is not authentic.
Example Ex48. A method for indicating inauthenticity of a consumable inserted into a receptacle of an aerosol generating apparatus, comprising: determining that the consumable inserted in the receptacle is not authentic; and one or both of releasing a scent from the apparatus and marking the consumable after the consumable is inserted into the receptacle.

### Example Ex49. the Method of Example Ex48, Comprising Releasing the Scent.

Example Ex50. The method of Example Ex49, wherein the released scent has an unpleasant odor, including ammonia or sulphur compounds.
Example Ex51. The method of one or more of Examples Ex48 to Ex50, wherein the method comprises marking the consumable with a visible marking.
Example Ex52. The method of Example Ex51, wherein the visible marking comprises marking a word onto the consumable.
Example Ex53. The method of Example Ex52, wherein the method comprises burning a word onto the consumable.
Example Ex54. The method of Example Ex52, wherein the method comprises burning a word onto the consumable, wherein the word indicates the consumable is counterfeit or inauthentic.

Referring now to the drawings, in which some aspects of the present invention are illustrated. It will be understood that other aspects not depicted in the drawings fall within the scope and spirit of the present invention. The drawings are schematic drawings and are not necessarily to scale. Like numbers used in the figures refer to like components, steps and the like. However, it will be understood that the use of a number to refer to a component in a given figure is not intended to limit the component in another figure labelled with the same number. In addition, the use of different numbers to refer to components in different figures is not intended to indicate that the different numbered components cannot be the same or similar to other numbered components.

FIG. 1 is a schematic perspective view showing an example of an apparatus and a consumable being inserted into the apparatus.

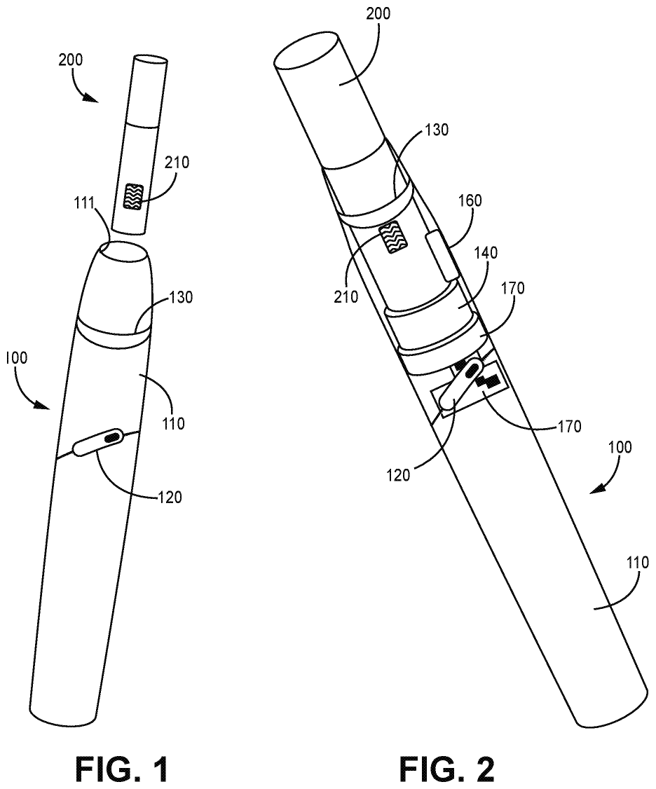

FIG. 2 is a schematic perspective view showing an example of an apparatus and a consumable inserted into the apparatus, with the housing of the apparatus being illustratively transparent.

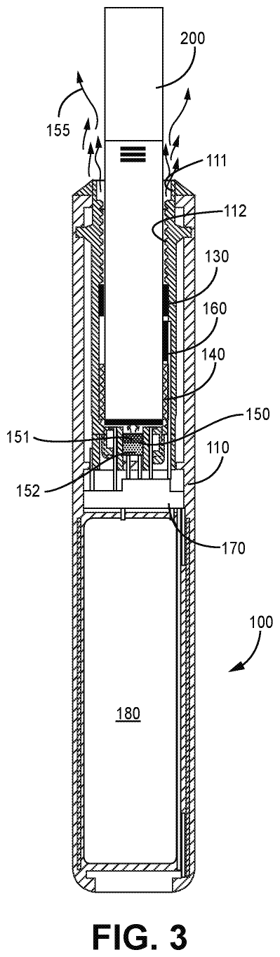

FIG. 3 is a schematic diagram cross-section view of the apparatus and a consumable inserted into the apparatus of FIG. 2.

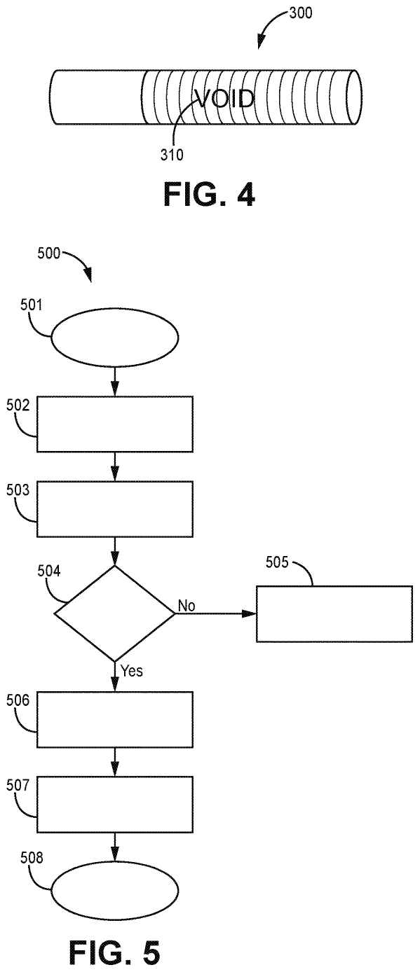

FIG. 4 is a schematic diagram side view of an illustrative consumable with counterfeit indicia.

FIG. 5 is an illustrative flow diagram of a method of indicating inauthenticity of a consumable with an apparatus according to the present invention.

FIG. 1 is a schematic perspective view showing an example of an apparatus 100 and a consumable 200 being inserted into the apparatus 100. FIG. 2 is a schematic perspective view showing an example of an apparatus 100 and a consumable 200 inserted into the apparatus 100, with a portion of the housing 110 of the apparatus 100 being illustratively transparent. FIG. 3 is a schematic diagram cross-section view of the apparatus 100 and a consumable 200 inserted into the apparatus 100 of FIG. 2.

The apparatus 100 is configured to interact with a consumable 200 to produce an aerosol. The apparatus 100 includes a receptacle 111 configured to receive the consumable 200, a sensor 130 configured to detect a feature 210 of the consumable 200 when the consumable 200 is received in the receptacle 111. A control unit 170 is operatively coupled to the sensor 130 and configured to determine whether the detected feature 210 is indicative of authenticity of the consumable. The apparatus 100 further includes one or both of a scent releasing unit 150 and a marking unit 160.

The scent releasing unit 150 is operatively coupled to the control unit 170. The control unit 170 is configured to cause the scent releasing unit 150 to release a scent 155 when the control unit 170 determines that the consumable 200 is not authentic or is counterfeit.

The marking unit 160 is operatively coupled to the control unit 170. The control unit 170 is configured to cause the marking unit 160 to mark the consumable 200 received in the receptacle 111 when the control unit 170 determines that the consumable 200 is not authentic or is counterfeit.

The sensor 130 may be any useful sensor able to interrogate a detectable feature 210 on or in the consumable 200 to determine the authenticity of the consumable 200.

The sensor 130 may be a radio frequency identification (RFID) sensor or reader that emits radio waves and receives signals back from a corresponding radio frequency identification (RFID) tag recognition element 210 on the consumable 200. The RFID tag recognition element 210 on the consumable 200 may be a passive element that is powered by the (RFID) sensor or reader 130. The RFID reader or sensor 130 is configured to interrogate the (RFID) tag recognition element 210 on the consumable 200 to verify the authenticity of the consumable 200 by its transmitted data.

The sensor 130 may be a chromatic, spectroscopic, or light sensor 130 that is configured to interrogate or read a corresponding recognition element 210 on the consumable 200. The recognition element 210 may be include a taggant or chromatic security feature to verify the authenticity of the consumable 200 by its spectroscopic or taggant signature.

The figures illustrate an apparatus 100 with both a scent releasing unit 150 and a marking unit 160. In some embodiments the apparatus 100 includes the scent releasing unit 150 but not the marking unit 160. In some embodiments the apparatus 100 includes the marking unit 160 but not the scent releasing unit 150. In some the apparatus 100 includes both the scent releasing unit 150 and the marking unit 160.

The scent releasing unit 150 may be configured to release a compound 155 having an unpleasant or offensive odor. The scent releasing unit 150 may be contained within the housing 110 of the apparatus 100. The scent releasing unit 150 may be contained within the receptacle 111 of the apparatus 100. The scent releasing unit 150 is operably coupled to the control unit 170 and the control unit may activate the scent releasing unit 150 (when present) upon detecting a counterfeit or inauthentic consumable 200 received in the receptacle 111 of the apparatus 100.

The scent releasing unit 150 may include at least one scent releasing elements 151 such as a heater or heating element, a vibration generator, an ultrasonic or piezoelectric transducer, an atomizer, or any other actuator to energize particles of a scent such that the particles are released from a scent container or cartridge 152 into a gas form or microscopic droplets that can be carried off by an airstream passing through a scent-flow channel 112, between the consumable 200 and the receptacle 111. The receptacle 111 may be wave-shaped at its inner surface, to improve transmission of an airstream passing through the scent-flow channel 112 and for holding the consumable 200, housed in the receptacle 111, securely in its position.

In the exemplary embodiment of FIG. 3, the scent releasing unit 150 includes a heater 151 configured to heat a substrate 152 containing the compound and causing the compound 155 to be released. The scent releasing element 151 may be a mesh heater configured to heat and releases a scent 155 from a flavored liquid-soaked high retention material or substrate incorporated in the scent cartridge 152. The released scent 155 may be directed toward the consumer of the consumable 200 via a channel or scent-flow channel 112 as illustrated in FIG. 3.

If the inauthenticity of a consumable 200 is detected by the sensor 130, the control unit 170 will activate the scent releasing unit 150 and release an unpleasant scent to the consumer or the counterfeit consumable 300. One unpleasant scent is perceived as strongly bitter and is composed by a suitable aroma and glycol. Other unpleasant scents include, for example, ammonia compounds, or sulfur compounds. By releasing an unpleasant scent when detecting a counterfeit consumable 300, a consumer will potentially associate the scent with the counterfeit consumable 300 and will more likely not use counterfeit consumables 300 in the future.

The marking unit 160 is configured to place in indicia 310 onto the surface of the consumable 200 to provide visual evidence that it is a counterfeit consumable 300. FIG. 4 illustrates a consumable 300 with the term “VOID” as indicia. The indica provided by the marking unit 160 may be any useful indication of authenticity, such as, the terms “FAKE”, “COUNTERFEIT”, or “DEFECTIVE”, for example.

The marking unit 160 may include a heater configured to burn the visible marking or indicia into the consumable 200. The marking unit 160 may be contained within the housing 110 of the apparatus 100. The marking unit 160 may be contained within the receptacle 111 of the apparatus 100. The marking unit 160 is operably coupled to the control unit 170 and the control unit may activate the marking unit 160 (when present) upon detecting a counterfeit or inauthentic consumable 200 received in the receptacle 111 of the apparatus 100.

The marking unit 160 may mark the consumable 200 while received in the receptacle 111 of the apparatus 100. When the inauthenticity of a consumable 300 is detected by the sensor 130, the control unit 170 activates the marking unit 160 to label the counterfeit identification mark 310 in a visible area of the consumable 300. The marking unit 160 may be designed incorporating at least one heating element able to burn-in individual letters, symbols or a word, such as “VOID”, “FAKE”, “COUNTERFEIT”, or “DEFECTIVE” into the consumable 300, when an inauthentic consumable 300 is detected within the receptacle 111 of the apparatus 100.

To power the apparatus 100 described herein, the operation of a sensor 130, control unit 170, the scent releasing unit 150, and the marking unit 160, a power source 180 is electrically connected to supply the required energy.

An actuation element 120 or actuation button 120 is operatively coupled to the control unit 170. The actuation element 120 is configured to be actuated by a user of the apparatus 100. Actuation of the actuation element 120 causes the control unit 170 to determine whether the detected feature 210 is indicative of authenticity of the consumable 200.

Actuation of the actuation element 120 is configured to cause the apparatus 100 to interact with the consumable 200 to produce the aerosol if the control unit 170 determines that the consumable 200 is authentic. In many embodiments, the control unit 170 is configured to prevent the apparatus 100 from interacting with the consumable 200 to produce the aerosol if the control unit 170 determines that the consumable 200 is not authentic.

FIG. 5 is an illustrative flow diagram 500 of a method of indicating inauthenticity of a consumable 300 with an apparatus 100 according to the present invention. The apparatus 100 or aerosol-generating device 100 may be operated in a recognition and prevention process at step 501. In doing so, a consumer will insert in a first step a consumable 200 into the receptacle 111 and will push with an axial force the consumable 200 into a heating element 140 at step 502.

When the consumer presses an activation button 120, a recognition process will be started at step 503. Thereby the recognition unit or sensor 130 will check if the inserted consumable 200 incorporates a recognition element 210 and determines if the consumable is counterfeit, at step 504.

If the recognition unit or sensor 130 determines the consumable 200 is not counterfeit (No), the control unit 170 activates the heating element 140 to generate an inhalable aerosol for a consumer at step 505.

On the other hand, if the recognition unit or sensor 130 detects a counterfeit consumable 300 (Yes), the control unit 170 sends a signal to disable the heating element 140 and may send an activation signal to the marking unit 160 to label a counterfeit identification mark 310 on the detected counterfeit consumable (300) at step 506.

At the same time or after marking the counterfeit consumable 300, the control unit 170 may send an activation signal to the scent releasing unit 150 at step 507. Thereby the scent releasing element 151 will be activated, and an unpleasant scent will be released from the cartridge 152 and detected by the consumer as well as other persons in proximity to the consumer. This results in marking the consumable 300 as counterfeit and the release of an unpleasant scent from the apparatus 100 at step 508.

It is understood that either the marking step 506 or the scent release step 507 may occur in any order or one of the marking step 506 or the scent release step 507 may not occur at all.

The specific embodiments described above are intended to illustrate the invention. However, other embodiments may be made without departing from the scope of the invention as defined in the claims, and it is to be understood that the specific embodiments described above are not intended to be limiting.

As used herein, the singular forms “a,” “an,” and “the” encompass embodiments having plural referents, unless the content clearly dictates otherwise.

As used herein, “or” is generally employed in its sense including “and/or” unless the content clearly dictates otherwise. The term “and/or” means one or all the listed elements or a combination of any two or more of the listed elements.

As used herein, “have,” “having,” “include,” “including,” “comprise,” “comprising” or the like are used in their open-ended sense, and generally mean “including, but not limited to”. It will be understood that “consisting essentially of,” “consisting of,” and the like are subsumed in “comprising,” and the like.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

1. An apparatus configured to interact with a consumable to produce an aerosol, the apparatus comprising:
a receptacle configured to receive the consumable;
a sensor configured to detect a feature of the consumable when the consumable is received in the receptacle;
a control unit operatively coupled to the sensor and configured to determine whether the detected feature is indicative of authenticity of the consumable; and
one or both of a scent releasing unit and a marking unit,
wherein the scent releasing unit is operatively coupled to the control unit, and the control unit is configured to cause the scent releasing unit to release a scent when the control unit determines that the consumable is not authentic, and
wherein the marking unit is operatively coupled to the control unit, and the control unit is configured to cause the marking unit to mark the consumable received in the receptacle when the control unit determines that the consumable is not authentic.

2. The apparatus of claim 1, wherein the sensor comprises an RFID reader.

3. The apparatus of claim 1, comprising the scent releasing unit.

4. The apparatus of claim 3, wherein the scent releasing unit is configured to release a compound having an unpleasant odor.

5. The apparatus of claim 4, wherein the scent releasing unit comprises a heater configured to heat a substrate comprising the compound, wherein heating the substrate causes the compound to be released.

6. The apparatus of claim 4, comprising a channel configured to carry the released compound towards a consumer of the consumable.

7. The apparatus of claim 1, comprising the marking unit.

8. The apparatus of claim 6, wherein the marking unit comprises a heater configured to burn a visible marking into the consumable.

9. The apparatus of claim 1, wherein the apparatus comprises an actuation element operatively coupled to the control unit, wherein the actuation unit is configured to be actuated by a user of the apparatus, and wherein actuation of the actuation element causes the control unit to determine whether the detected feature is indicative of authenticity of the consumable.

10. The apparatus of claim 9, wherein actuation of the actuation element is configured to cause the apparatus to interact with the consumable produce the aerosol if the control unit determines that the consumable is authentic.

11. The apparatus of claim 10, wherein the control unit is configured to prevent the apparatus from interacting with the consumable to produce the aerosol if the control unit determines that the consumable is not authentic.

12. A method for indicating inauthenticity of a consumable inserted into a receptacle of an aerosol generating apparatus, comprising:
determining that the consumable inserted in the receptacle is not authentic; and
one or both of releasing a scent from the apparatus and marking the consumable after the consumable is inserted into the receptacle.

13. The method of claim 12, comprising releasing the scent.

14. The method of claim 13, wherein the released scent has an unpleasant odor.

15. The method of claim 12, wherein the method comprises marking the consumable with a visible marking.
